(19) United States
(12) Patent Application Publication
(10) Pub. No.: US 2014/0333057 A1
(43) Pub. Date: Nov. 13, 2014

(54) BOOK JACKET WHICH ACCOMMODATES PAIR OF EYEGLASSES

(71) Applicant: ACTION EYEWEAR CORP., TAIPEI CITY (TW)

(72) Inventor: CHOON KHEANG NG, WEST MALAYSIA (MY)

(73) Assignee: ACTION EYEWEAR CORP., TAIPEI CITY (TW)

(21) Appl. No.: 14/104,623

(22) Filed: Dec. 12, 2013

(30) Foreign Application Priority Data
May 10, 2013 (CN) 201320251473.X

(51) Int. Cl. B42D 3/04

(52) U.S. Cl. CPC B42D 3/04
USPC 281/31

(57) ABSTRACT

The present disclosure pertains to a book jacket which can accommodate eyeglasses and a book. The book jacket includes a book jacket main body and pockets disposed respectively at two ends of the book jacket main body. An inner layer is disposed at the inner surface of the book jacket main body. When the book jacket is folded, the folding inner layer spine portion and the folding book jacket spine portion define an accommodating space therebetween. The book jacket spine portion has a slit, and a storage pull tab, one end of which is fixed to the inner layer spine portion, and the other end of which passes through the slit of the book jacket spine portion and extends outward. The inner layer spine portion has a bookmark. The present disclosure cleverly forms an accommodating space for storing eyeglasses in the book jacket.

### BACKGROUND OF THE INVENTION

1. Field of the Invention

The present disclosure relates to a book cover; in particular, to a book cover which can accommodate eyeglasses and a book.

2. Description of Related Art

Books are a part of daily lives of people. Many people have books in their homes, and book lovers protect their books, especially important and precious books, with book jackets. Oftentimes, people need to wear glasses when reading to fix conditions such as myopia and presbyopia. However, glasses for presbyopia are not regularly worn, and are mostly worn only during reading. In light of this, a tool for accommodating a pair of glasses and a book together, e.g. a book jacket having an accommodating space for eyeglasses, facilitates the storage of eyeglasses for reading and protects the book at the same time

### SUMMARY OF THE INVENTION

The object of the present disclosure is to a book jacket which protects a book, in particular to a book jacket which can accommodate eyeglasses and a book.

In order to achieve the aforementioned objects, the present disclosure employs the following technical features. A book jacket which can accommodate eyeglasses includes a book jacket main body and pockets disposed respectively at the left end and the right end of the book jacket main body. An inner layer is disposed at the inner surface of the book jacket main body. When the book jacket is folded, the folding inner layer spine portion and the folding book jacket spine portion define an accommodating space therebetween. The book jacket spine portion has a slit, and a storage pull tab. One end of the storage pull tab is fixed to the inner layer spine portion, and the other end of the storage pull tab passes through the slit of the book jacket spine portion and extends outward. The inner layer spine portion has a book mark.

The shape of the inner layer is adapted to the shape of the book jacket main body. The dimensions of the inner layer spine portion are smaller than the dimensions of the book jacket spine portion

The edges of the inner layer is fixed to the book jacket main body, and the inner layer spine portion having smaller dimensions than the dimensions of the book jacket spine portion is not fixed, such that the inner layer spine portion and the book jacket spine portion define an accommodating space therebetween.

The width of the storage pull tab is greater than or equal to 2 cm. The end of the storage pull tab extending out of the slit of the book jacket spine portion has a Velcro fastener and is attached to the slit portion.

The top part of the book jacket spine portion has a Velcro fastener for adhering to the Velcro fastener of the storage pull tab.

The length of the book mark is greater than the length of the book jacket main body. One end of the bookmark is fixed to the upper edge of the inner layer spine portion.

The present disclosure cleverly forms an accommodating space for storing eyeglasses in the book jacket, successfully accommodating eyeglasses and a book in the book jacket. The book jacket not only protects the book, but can also safely store and protect eyeglasses. The structure of the book is aesthetic and easy to use.

In order to further the understanding regarding the present disclosure, the following embodiments are provided along with illustrations to facilitate the disclosure of the present disclosure.

### BRIEF DESCRIPTION OF THE DRAWINGS

FIG. 1 shows a schematic diagram of the present disclosure; and

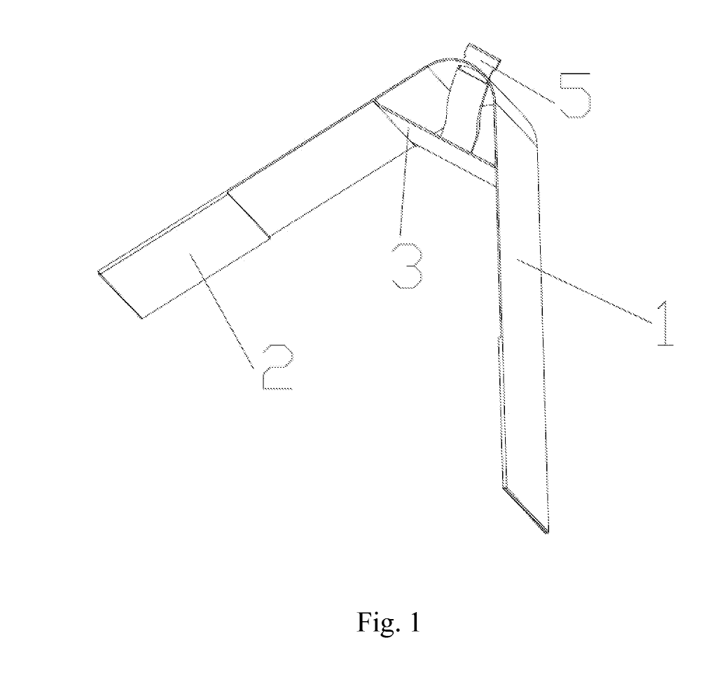

FIG. 2 shows a back view of the present disclosure when open.

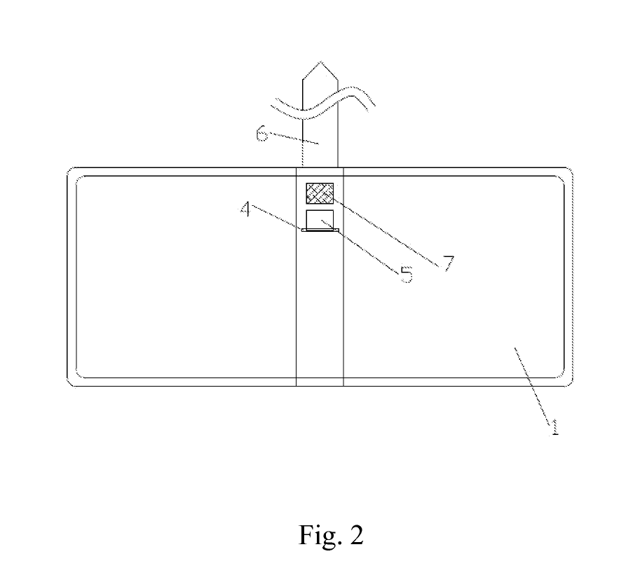

### DETAILED DESCRIPTION OF THE PREFERRED EMBODIMENTS

The aforementioned illustrations and following detailed descriptions are exemplary for the purpose of further explaining the scope of the present disclosure. Other objectives and advantages related to the present disclosure will be illustrated in the subsequent descriptions and appended drawings.

A book jacket which can accommodate eyeglasses includes a book jacket main body 1 and pockets 2 disposed at the two ends of the book jacket main body 1. The pockets 2 house respectively the first page and the last page of the book, and the book jacket 1 is folded to wrap around the book. The inner surface of the book jacket main body has an inner layer 3. The edges of the inner layer 3 is fixed to the book jacket main body 1, and the inner layer 3 spine portion has dimensions smaller than the dimensions of the book jacket main body 1 spine portion and is not fixed, such that the inner layer 3 spine portion and the book jacket main body 1 spine portion define an accommodating space therebetween. The shape of the inner layer 3 is adapted to the shape of the book jacket main body 1. The dimensions of the inner layer 3 spin portion are smaller than the dimensions of the book jacket main body 1 spine portion. When the book jacket is folded, the folding inner layer 3 spine portion and the folding book jacket main body 1 spine portion define an accommodating space therebetween. The length and the width of the accommodating space are generally the same as or greater than the dimensions of a typical pair of eyeglasses, facilitating the storage of eyeglasses. The book jacket main body 1 spine portion has a slit 4, and a storage pull tab 5. One end of the storage pull tab 5 is fixed to the inner layer 3 spine portion, and the other end of the storage pull tab 5 passes through the slit 4 of the book jacket main body 1 spine portion and extends outward. The width of the storage pull tab 5 is greater than or equal to 2 cm. The end of the storage pull tab 5 extending out of the slit 4 of the book jacket main body 1 spine portion has a Velcro fastener and is attached to the slit portion 4. When storing the eyeglasses, push the eyeglasses into the accommodating space such that the eyeglasses press the storage pull tab 5 and the pull tab 5 is drawn inward. When the eyeglasses are completely disposed inside the accommodating space, the end of the storage pull tab 5 extending out of the slit 4 is positioned next to the Velcro fastener 7 disposed on the book jacket main body 1 spine portion and above the slit 4 for working in concert with the storage pull tab 5. Then, adhere the Velcro fastener 7 on the outer end of the storage pull tab 5 to the Velcro fastener 7 on the book jacket main body 1 spine portion. When the eyeglasses are to be retrieved, separate the Velcro fasteners 7 and pull the storage pull tab 5 outward, such that the storage pull 5 abutting the eyeglasses pushes the eyeglasses out of the accommodating space for convenient removal by the user. This design does not affect the outward appearance of the book jacket, and facilitates the disposal and removal of eyeglasses. The inner layer 3 spine portion has a bookmark 6. The length of the bookmark 6 is greater than the length of the book jacket main body 1. The bookmark 6 is fixed to the top portion of the inner layer 3 spine portion for marking the pages when reading.

The descriptions illustrated supra set forth simply the preferred embodiments of the present disclosure; however, the characteristics of the present disclosure are by no means restricted thereto. All changes, alternations, or modifications conveniently considered by those skilled in the art are deemed to be encompassed within the scope of the present disclosure delineated by the following claims.

1. A book jacket which accommodates eyeglasses, comprising:
a book jacket main body;
pockets disposed respectively at the two ends of the book jacket main body;
an inner layer disposed at the inner surface of the book jacket main body;
wherein when the book jacket is folded, a folding inner layer spine portion and a folding book jacket spine portion define an accommodating space therebetween, the book jacket spine portion has a slit and a storage pull tab, one end of the storage pull tab is fixed to the inner layer spine portion, the other end of the storage pull tab passes through the slit of the book jacket spine portion and extends outward, and the inner layer spine portion has a book mark;
wherein the storage pull tab is configured for being pressed inwardly when the eyeglasses are pushed into the accommodating space, and the storage pull tab is capable of pushing the eyeglasses out of the accommodating space when the storage pull tab is pulled outwardly.

2. The book jacket which accommodates eyeglasses according to claim 1, wherein the shape of the inner layer is adapted to the shape of the book jacket main body, and the dimensions of the inner layer spine portion are smaller than the dimensions of the book jacket main body spine portion.

3. The book jacket which accommodates eyeglasses according to claim 1, wherein the edges of the inner layers are fixed to the book jacket main body, the inner layer spine portion having dimensions smaller than the dimensions of the book jacket spine portion is not fixed, an accommodating space is defined between the inner layer spine portion and the book jacket main body spine portion.

4. The book jacket which accommodates eyeglasses according to claim 2, wherein the edges of the inner layers are fixed to the book jacket main body, the inner layer spine portion having a dimensions smaller than the dimensions of the book jacket spine portion is not fixed, defining an accommodating space between the inner layer spine portion and the book jacket main body spine portion.

5. The book jacket which accommodates eyeglasses according to claim 1, wherein the width of the storage pull tab is at least 2 centimeters, and the end of the storage pull tab extending out of the slit of the book jacket spine portion has a Velcro-like fastener and is attached to the slit portion.

6. The book jacket which accommodates eyeglasses according to claim 1, wherein another Velcro-like fastener for adhering to the Velcro-like fastener of the storage pull tab is disposed on the book jacket spine portion above the slit.

7. The book jacket which accommodates eyeglasses according to claim 1, wherein the length of the bookmark is greater than the length of the book jacket main body, and one end of the bookmark is fixed to the top portion of the inner layer spine portion.
